(19) United States
(12) Patent Application Publication
(10) Pub. No.: US 2010/0187212 A1
(43) Pub. Date: Jul. 29, 2010

(54) Tire Warmer

(75) Inventor: Maurizio Peruzzo, Vicenza (IT)

Correspondence Address: SHOEMAKER AND MATTARE, LTD, 10 POST OFFICE ROAD - SUITE 100, SILVER SPRING, MD, 20910, US

(73) Assignee: O.R.V. OVATTIFICIO RESINATURA VALPADANA S.P.A., Grantorto, Padova (IT)

(21) Appl. No.: 12/667,416

(22) PCT Filed: Jul. 2, 2008
(86) PCT No.: PCT/IB08/52658

§ 371 Date: Mar. 1, 2010

(30) Foreign Application Priority Data
Jul. 2, 2007 (IT) PD2007A000225

(51) Int. Cl. B60L 1/02

(52) U.S. Cl. 219/202

(57) ABSTRACT

The present invention relates to a tire warmer, in particular for tires to be used in motor-cycling and motor-racing, which comprises a body wrappable to the wheel, at the tire, and seating a resistor for heating the tire. Such resistor is connected to electrical supply means actuable by a control device connected to a temperature sensor associable to the tread of the tire. Moreover, the tire warmer comprises a regulating device of the pressure of gas contained by the tire.

### FIELD OF APPLICATION

The present finding relates to a tire warmer, in particular for tires to be used in motor-cycling and motor-racing.

### PRIOR ART

Devices for warming tires known as tire warmers are currently known.

Such devices are provided with a body that may be wrapped up on the tire provided with a resistor suitable for warming it and with a temperature sensor generally applied to the tread.

The temperature sensor is usually connected to a switch that cuts or enables the electrical supply of the resistor respectively upon reaching an upper limit or a lower limit by the temperature detected by the sensor.

So, once the tire warmer is activated, the temperature of the tire it is wrapped to, detected by the sensor, is brought and kept between such upper and lower limits.

A tire warmer activity indicator indicates to the user whether the temperature detected has reached or not the range comprised within the preset limits, that is, if the tire is ready for use or not.

A disadvantage of such device consists in the fact that the temperature detected by the sensor, since this is generally applied to the tread, is substantially the temperature at which the outer tire surface is, whereas the temperature of the inner tire face, that of the gas contained thereby and that of the support rim thereof, may be different.

Particularly if a tire is used during a race while its temperature is not even, exhibiting instead a gradient along the tire thickness, the performance as well as the life of the latter are impaired, to the disadvantage of the vehicle performance and the driver's safety.

In the field of motor-cycling and motor-racing, in particular, the need for a tire warmer is therefore felt, which should be capable of indicating to the user when the entire thickness of the tire reaches the preset temperature.

### DISCLOSURE OF THE INVENTION

The purpose of the present invention therefore is to eliminate the disadvantages of the prior art mentioned above by providing a tire warmer, in particular for tires to be used in motor-cycling and motor-racing, which should allow checking when the entire thickness of the tire reaches the preset temperature.

Within such purpose, a further object of the invention is to provide a tire warmer which should allow setting and controlling the pressure of the gas contained by the tire.

Within such purpose, a further object of the finding is to provide a tire warmer which should allow setting and maintaining the pressure of the gas contained by the tire.

Another object of the invention is to propose a tire warmer structurally simple and easy to use, which may be manufactured at low cost.

### BRIEF DESCRIPTION OF THE DRAWINGS

The technical features of the invention, according to the above objects, are clearly found in the contents of the claims below and the advantages of the same will appear more clearly from the following detailed description, made with reference to the annexed drawings, which show one or more purely exemplifying and non-limiting embodiments thereof, wherein:

FIG. 1 shows a perspective view of a tire warmer according to a preferred embodiment of the invention;

FIG. 2 shows a diagram of the tire warmer illustrated in FIG. 1;

FIG. 3 shows a logical flow diagram relating to the operation of the tire warmer according to a first particular embodiment of the invention;

FIG. 4 shows a simplified graph of the temporal course of temperature and pressure inside the tire during the use of a tire warmer according to the invention, in accordance with the particular embodiment illustrated in the diagram of FIG. 3;

FIG. 5 shows a logical flow diagram relating to the operation of the tire warmer according to a second particular embodiment of the invention;

FIG. 6 shows a simplified graph of the temporal course of temperature and pressure inside the tire during the use of a tire warmer according to the invention, in accordance with the particular embodiment illustrated in the diagram of FIG. 5;

FIG. 7 shows a logical flow diagram relating to the operation of the tire warmer according to a third particular embodiment of the invention;

FIG. 8 shows a simplified diagram of the temporal course of temperature and pressure inside the tire during the use of a tire warmer according to the invention, in accordance with the particular embodiment illustrated in the diagram of FIG. 7;

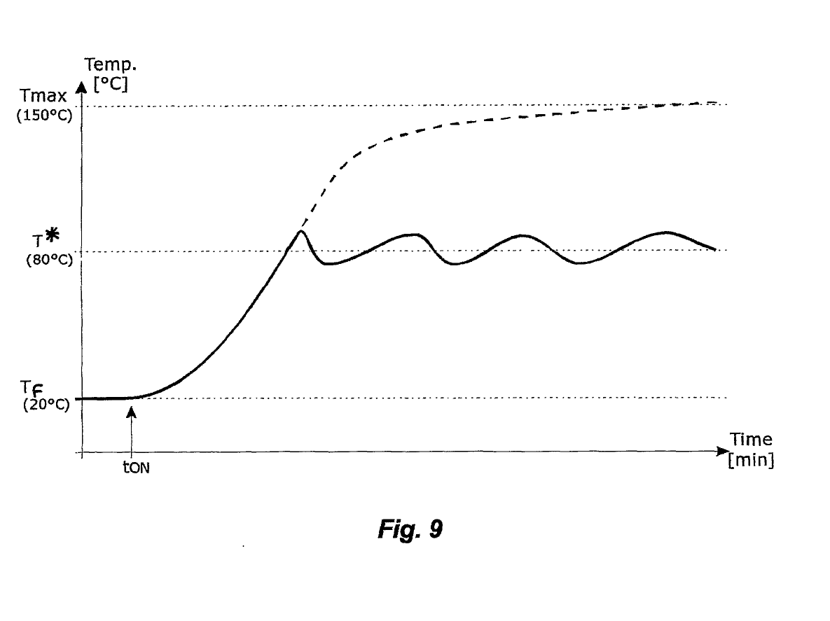

FIGS. 9 and 10 show two graphs relating to two different ways of warming the tire using the tire warmer according to the invention; and

FIG. 11 shows a graph relating to the pressure course during a tire deflation process.

### DETAILED DESCRIPTION

With reference to the above figures, reference numeral 10 globally indicates a tire warmer, in particular for tires to be used in motor-cycling and motor-racing, according to the invention.

According to a general solution of the invention, tire warmer 10 comprises a body 11, wrappable around wheel 12 at tire 13. In turn, body 11 seats a resistor 14 for warming tire 13 connected to power supply means 15.

Preferably, body 11 comprises a heating panel, an insulating layer and an external cover, overlapped to one another.

More in detail, the heating panel has a sandwich structure, with a first layer and a second layer enclosing a core. The first layer, intended for contacting the tire, is composed of a fire retardant, non-sticking, abrasion-proof material and is provided with high capacity of diffusion of the temperature. This first layer may be made, for example, using a metal fibre and polyester and/or polyamide (nylon) fibre fabric. The central layer (core) defines the resistor and is preferably, but not necessarily, composed of one or more filaments of carbon fibres covered with a thermo-conductive silicone layer. The resistor may also be made of other materials, for example one or more copper or constantan wires covered with Teflon. Filaments and wires are arranged so as to cover all the surface intended for resting on the tread so as to have an even distribution of the temperature during heating. The second layer serves as support for the resistor and is made of a fire retardant non-woven fabric (for example felt) that also serves as insulator.

The insulating layer is made of a single layer, for example felt, whereas the outer covering layer is made of a fabric or a non-woven fabric, preferably plasticized (polyurethane or PVC) or subject to other oil-water repellent treatments.

The electrical supply means 15 are actuable by a control device 16 connected to a temperature sensor 17 associable to wheel 12 for detecting the tire temperature.

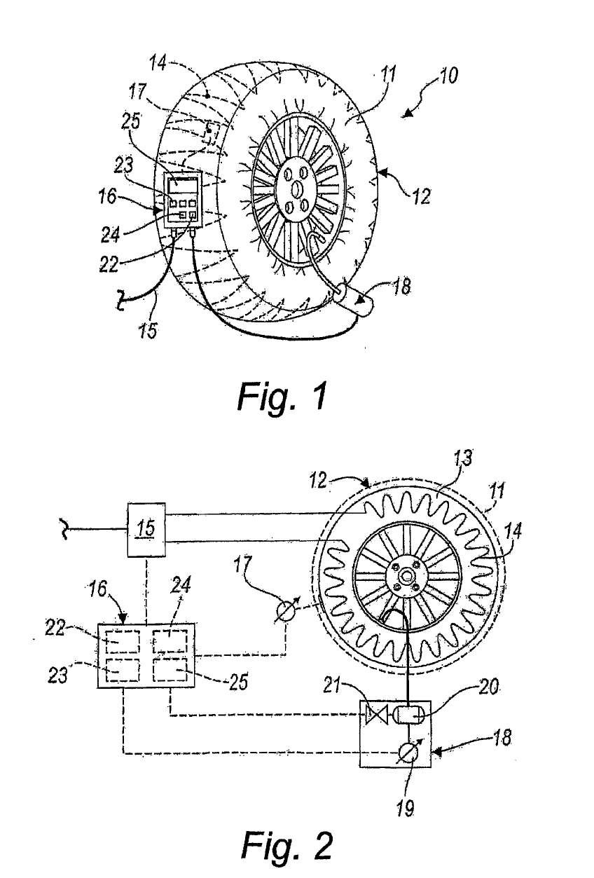

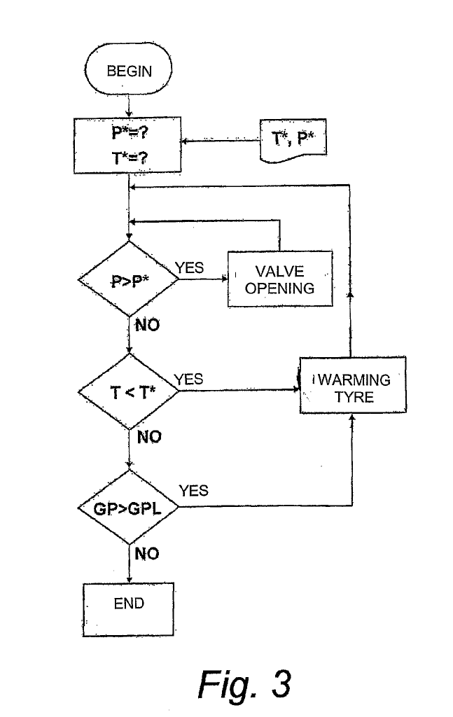

According to a first embodiment of the invention, illustrated in FIGS. 1 and 2, the temperature sensor 17 is of the type associable to the tread of tire 13.

More in detail, sensor 17 is arranged within tire warmer 10 so that with the tire warmer mounted on the wheel, the sensor has its sensitive portion in contact, either direct or indirect, with the tread and can thus detect the surface temperature of the tire itself.

The solution described above, simple to make and immediately applicable on the field, allows detecting only the surface temperature of the tire tread.

According to a second embodiment of the invention, not illustrated in the annexed figures, the temperature sensor is of the type to be buried in tire 13.

This solution allows having a more reliable estimate of the inside temperature of the tire wall. However, its adoption requires a series of operating difficulties since it is necessary to involve the tire manufacturer.

According to a third embodiment of the invention, not illustrated in the annexed figures, the temperature sensor is of the type associable to the rim of wheel 12.

More in detail, the sensor is attached to the rim in such position as to allow detecting the temperature of the set given by tire, inflation gas and rim and thus, the temperature of the tire inflation gas.

This solution is operatively easy to apply but requires a more complex data processing to estimate the tire temperature.

According to a peculiar aspect of the invention, the tire warmer may comprise a regulating device 18 of the pressure of gas contained in tire 13.

Advantageously, the regulating device 18 of the gas pressure in turn comprises a device for detecting the pressure of gas contained by tire 13.

As will be explained in detail hereinafter, knowing the inflation pressure value P of the tire allows estimating temperature T of the tire inflation gas and thus, indirectly, the inner temperature of the wall of the tire itself.

More in detail, taken the tire deformability as negligible (at least within the limits of a standard use of the tire) and therefore the inner tire volume as constant, the gas behaviour inside the tire may be considered as described by isochor transformations.

Taking an ideal behaviour of the gas, according to the second law of Gay-Lussac it is thus possible to consider the ratio P/T between pressure and temperature inside the tire as constant. Therefore, as the gas temperature T increases, also the inside pressure P of the tire increases in a directly proportional manner.

As a consequence, measuring the pressure variations P over time it is possible to obtain an estimate of the variation of the gas temperature T and thus of the variation of the tire inner surface temperature.

Disclosing what will be described in detail hereinafter, starting from the assumption made on the gas behaviour inside the tire, the tire warmer according to the invention is preferably used assuming that following the heating action of the resistors, the tire has reached even temperature conditions through all the wall thickness when a pressure gradient over time (hereinafter indicated as GP) close to zero is detected.

Advantageously the control device 16 of tire warmer 10 is thus set for actuating the electrical supply means 15 according to the pressure gradient over time GP detected inside tire 13.

In particular, the control device 16 is set for considering a pressure gradient over time GP close to zero come as indicator of absence of thermal gradient in the tire wall thickness.

According to a preferred embodiment of the invention, the pressure gradient over time GP is considered substantially close to zero when it is below 0.1 mbar/s, and even more preferably when it is below 0.040 mbar/s. Operatively, a threshold or limit value is set (hereinafter indicated as GPL) comprised within the range between about 0.035 mbar/s and about 0.040 mbar/s, preferably setting it equal to 0.037 mbar/s.

According to a preferred embodiment of the invention, illustrated in FIGS. 1 and 2, the pressure sensor 19 is connected to an external pressure chamber 20 connected to the tire inflation valve.

More in detail, the pressure regulating device 18 comprises:
a pressure chamber 20, connected to wheel 12 and suitable for receiving a portion of the gas contained therein;
a device for detecting the pressure of the gas contained by said tire, suitably consisting of a pressure sensor 19 (in se known), connected to the pressure chamber 20 for detecting the pressure of gas contained therein; and
a deflation electrovalve 21, for example a solenoid valve, connected to the pressure chamber 20 for ejecting the gas contained therein on a command.

Operatively, as illustrated in FIG. 2, the regulating device 18 is connected to the control device 16 by the pressure sensor 19 and by electrovalve 21 respectively for detecting and regulating the pressure of the gas contained in the pressure chamber 20.

As an alternative to the preferred solution described above, the pressure sensor may be connected directly to the inner chamber of the tire so as to directly detect the inflation pressure, while the deflation electrovalve continues to be connected to the above pressure chamber.

More in detail, the pressure sensor may be of the type to be buried in the tire structure or it may be attached to the wheel rim in such position as to allow detecting the tire inflation gas pressure.

Preferably, in this case, the pressure regulating device comprises:
a pressure chamber 20, connected to wheel 12 and suitable for receiving a portion of the gas contained therein;
a device for detecting the pressure of the gas contained by the tire, suitably consisting of a pressure sensor 19 (in se known), directly connected to the tire inner chamber; and
a deflation electrovalve 21, for example a solenoid valve, connected to the pressure chamber 20 for ejecting the gas contained therein on a command.

Operatively, the detection device is connected to the control device by the pressure sensor 19 for detecting the pressure of the gas contained in the tire and by electrovalve 21 for regulating the pressure of the gas contained in the outer chamber 20.

Operatively, the temperature and pressure sensors must transmit the data detected to the control device.

Preferably, if sensors (pressure and/or temperature) are adopted, arranged externally to the wheel (i.e. not attached thereto), the connection with the control device is obtained by conductor wires. It is the case of a temperature sensor associable to the tread and of a pressure sensor connected to an external pressure chamber.

Preferably, if sensors (pressure and/or temperature) are adopted, arranged internally to the wheel (i.e. attached thereto), the connection with the control device is obtained by radio waves (wireless). It is the case of a temperature or pressure sensor to be buried in the tire or attached to the rim.

More in detail, wireless connections may be selected among all those available, according to the communication protocols, such as: Rfid with active tags; transponder; Wi.Fi.; WiMAX; Bluetooth; and ZigBee.

Advantageously, the wireless connection may be adopted also with sensors arranged externally to the wheel, as an alternative to the conductor wires.

Preferably, the control device 16 comprises:
a setting device 22, controllable by the user, for the inflation pressure and the heating temperature of tire 13, of in se known type, such as an electronic circuit provided with button controls;
a preselection device 23 for the heating speed of tire 13, of in se known type, such as an electronic circuit provided with button controls;
on/off means 24 of tire warmer 10, of in se known type, such as an electrical supply switch or an electronic circuit provided with button controls; and
electronic means 25 for signalling the operating conditions of tire warmer 10, of in se known type and suitably comprising a screen for displaying temperature T detected by the temperature sensor 17, pressure P detected by the pressure sensor 19, heating temperature T* and inflation pressure P* or Pf set for tire 13, by the setting means 24.

Herein and in the following description, the expression “heating temperature” (indicated with T*) means the final temperature whereat the tire is thermostated thanks to the regulation of the resistor supply. Operatively, the value of T* is selected by the user based for example on the type of tire, on the specific tire manufacturer instructions, on the features of the track and on the environmental conditions (ambient temperature, track temperature, humidity, etc.).

The expression “cold temperature” (indicated with Tf) means the temperature whereat the tire is prior to heating.

The expression “hot (inflation) pressure” (indicated with P*) means the final inner pressure of the tire, that is, at the end of the heating. Operatively, the value of P* is selected by the user based for example on the type of tire, on the specific tire manufacturer instructions, on the features of the track and on the environmental conditions (ambient temperature, track temperature, humidity, etc.).

The expression “cold (inflation) pressure” (indicated with Pf) means the inner pressure of the tire, before the heating begins.

Operatively, as will be explained hereinafter, according to some particular uses of tire warmer 10, cold pressure Pf should be such as to allow reaching the hot pressure P*, based on the heating degree (T*−Tf) to be imposed to the tire.

The tire is considered to be ready for use when temperature T is equal to T* in all the thickness of the wall of the tire itself and the inner pressure is equal to P*. Choosing correct tire inflation pressures and temperatures is fundamental for allowing using the tire at the maximum performance in terms of grip, life and safety.

Preferably, resistor 14 inserted in the wrappable body 11 of the tire warmer is sized for allowing a suitable warming of the tire, that is, such as to allow reaching temperatures up to 150° C. but without burning the tread rubber.

Advantageously, the control device 16, processing the data transmitted by the temperature sensor, can act on the resistor supply means so as to control the tire warming process.

A first regulating mode that may be adopted is ON/OFF type.

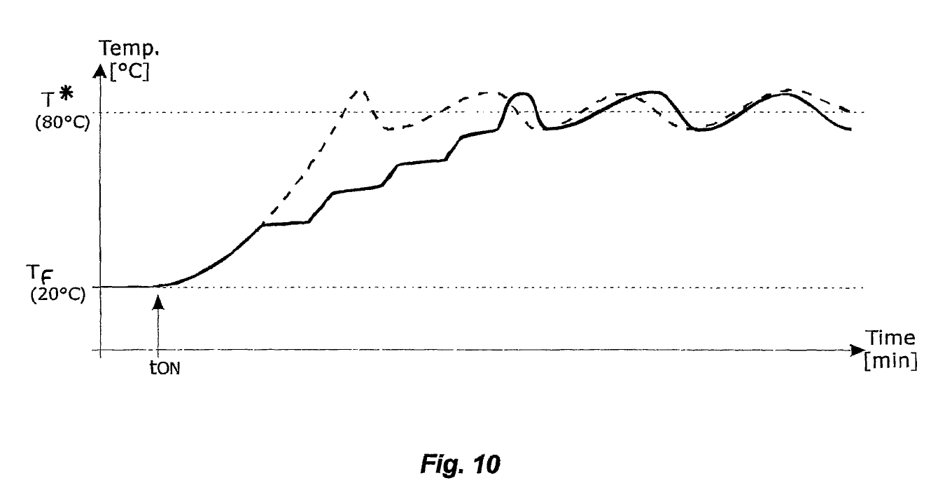

More in detail, the control device is provided with a switch or relay that connects or disconnects the resistor to/from the power supply. The graph of FIG. 9 shows an example of the typical course of the temperature detected by the temperature sensor with an ON/OFF control. In the specific example Tf is set equal to 20° C. and T* to 80° C. Tmax (150° C.) indicates the maximum temperature the tire would reach if there was no thermoregulation.

The dashed line shows the theoretical course of the temperature without thermoregulation, while the uninterrupted line curve shows the real course of the tire tread temperature in the presence of thermoregulation.

The control device provides supply to the resistor at time tON. The temperature starts to increase. When the temperature detected by the sensor reaches the value T* the control device interrupts the supply. By thermal inertia the temperature continues to increase beyond the T* value and then drops below T*, a condition where the control device restarts the resistor power supply. The temperature continues to oscillate around the value of T* with increasingly smaller ranges.

In particular situations it may be necessary to slow down the tire warming process.

Advantageously, the control device can act on the warming speed assessing the temperature increase over time and comparing it with predefined values. If such values are exceeded, the power supply to the resistor is interrupted by a predefined time. In this case, the temperature course is shown, by way of an example, by the uninterrupted line of the graph of FIG. 10.

Different warming modes (programs), preset or programmable by the user as desired, may be provided. For example, a quick warming mode may have 4° C./min as predefined limit, a medium mode a limit of 2° C./min, and a slow mode a limit of 1° C./min. Such values may vary according to the features of the tire and/or to the environmental conditions.

As an alternative to the ON/OFF regulating mode it is possible to provide for a regulating mode of the mean value of the resistor supply voltage.

More in detail, this control mode provides for the electronic regulation of the mean value of the resistor supply voltage. In this case it is possible to control the tire warmer power so as to obtain the desired temperature courses. The electronic power supply regulation may take place, for example, by phase choking, with an inverter or a variable voltage power supply.

Advantageously, the tire warmer according to the invention and the relative control device can operate in various manners according to the software program implemented and activated on the basis of the user requirements.

Three different alternative operating modes of tire warmer 10 according to the invention shall now be described.

As already mentioned before, the factors that affect the result of the tire preparation (preheating before the use on track) are cold temperature Tf, which presumably matches the ambient temperature, and the quantity of air contained in the tire (that is, the cold pressure Pf) when the warming cycle starts.

According to a first operating mode, the tire is warmed keeping the inner tire pressure constant to a preselected value of hot pressure P*.

More in detail, once body 11 of tire warmer 10 has been wrapped around tire 13 of wheel 12, the user by setting means 22 of the control device, sets the temperature value T* at which the tire warmer should warm tire 13. Likewise, the user sets the pressure value P* at which the tire warmer should keep tire 13.

Moreover, by the preselection device 23, the user sets a preselected warming speed of tire 13.

By the on/off means 24 the user activates the tire warmer.

The control device 16 then detects, by the pressure sensor 19, the value of pressure P of the gas contained in the pressure chamber 20, and thus indirectly, the pressure of the gas contained by tire 13.

If P>P*, the control device 16 actuated electrovalve 21 allowing the ejection of a part of the gas contained in the pressure chamber 20 and by tire 13; the control device 16 is suitably programmable for keeping the valve open for predefined times based on the difference between values P and P* (as will be specified hereinafter).

Otherwise, if it is not P>P* (that is, P≦P*), and if T<T*, then the control device 16 actuates the electrical supply means 15 of resistor 14 which warms up and warms tire 13.

If neither P>P* or T<T*, then the control device 16 assesses whether the temporal gradient of the pressure detected by the pressure sensor 19, indicated with GP, is greater than as predefined value GPL.

In that case, that is if GP>GPL, the control device continues warming tire 13, by the supply means 15, as well as the checks on the pressure value P.

Otherwise, that is if GP≦GPL, the control device interrupts the warming of tire 13 and by the signalling means 25 indicates to the user that the warming of tire 13 is completed and that the tire is ready for use. If the tire is not used immediately, the control device continues to actuate the resistors for thermostating the system to the temperature T* set.

In that case, in fact, the pressure detected by the pressure sensor 19 is substantially constant. This indicates a substantially constant temperature of the gas contained by tire 13, that is, absence of warming of such gas, and thus that tire 13 exhibits a temperature substantially even by all of the thickness thereof.

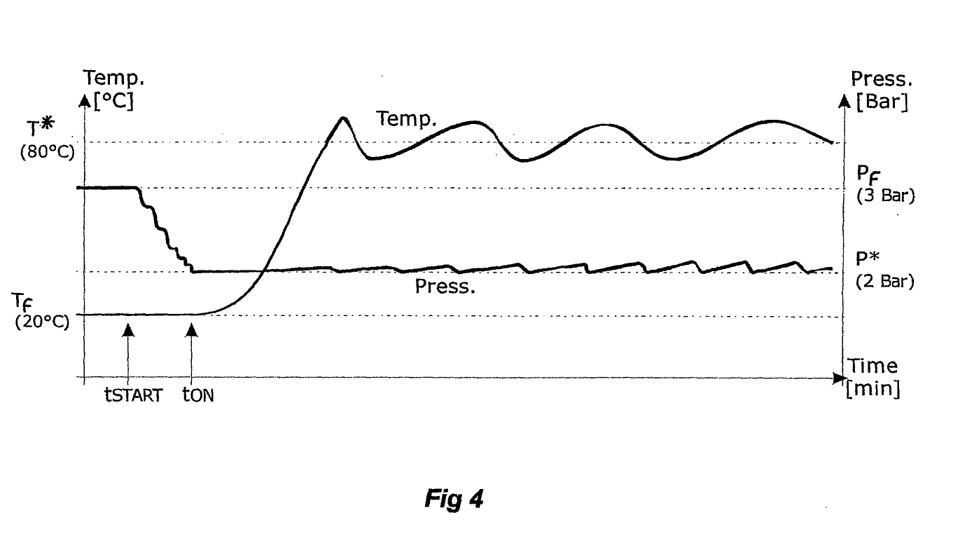

The logical diagram at the basis of the above first operating mode is shown in FIG. 3.

More in detail, following the diagram of FIG. 3, the user sets temperature T* at which the tire must be warmed and the pressure P* that the gas contained into the same must have at the end of the heating.

First, the pressure value transmitted by the sensor is determined and if it is higher than P*, the deflation electrovalve is actuated (according to specific modes described hereinafter) until the value of P is below or equal to P*.

At this point, the value of temperature T is determined and if it is less than the desired value T*, the resistor supply is activated.

The program continues to repeat the previous points until the temperature value reaches T*, a condition that implies the disconnection of the resistor from the power supply.

During the warming, the pressure rises proportionally to the temperature increase.

Each time the temperature T reaches value T* and the supply to the resistors is interrupted, the temporal gradient GP of pressure is determined.

If the pressure gradient detected GP is higher than a preset limit value GPL it means that there is still a temperature gradient between the tire tread and the support rim, that is, that the “tire+gas+rim” system is not thermally steady yet. In this case, the program repeats all the previous points (assessment and regulation of pressure and temperature) continuing to provide heat to the wheel.

If the pressure gradient detected GP is less or equal to GPL it means that the system is at steady condition and thus the wheel is ready for use.

If the tire is not used immediately, the tire warmer continues to thermostat the system to the temperature value T* set.

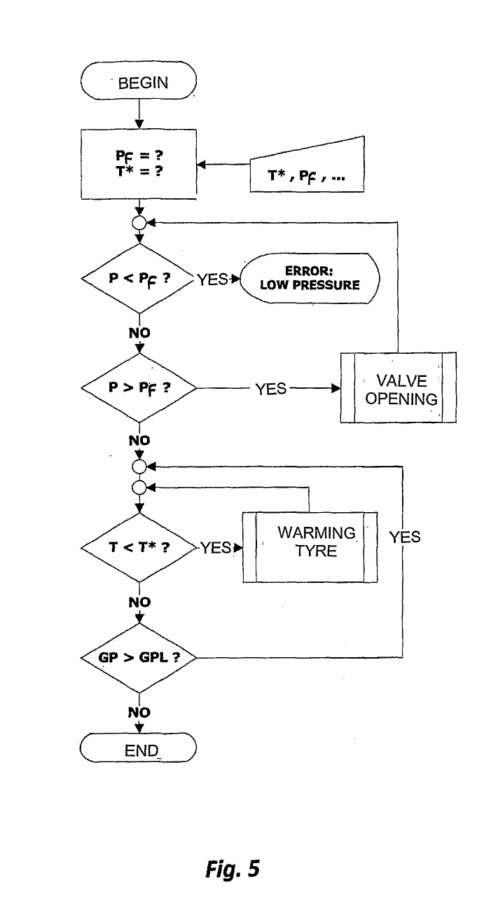

The graph of FIG. 4 shows the overlapped time courses of pressure P and temperature T during the use of the tire warmer according to the above first operating mode. The numerical values indicated are purely by way of an example.

More in detail, it has been assumed that at first the tire has an initial cold pressure Pf equal to 3 bar. The activation of the tire warmer takes place at the time indicated with tSTART. Before activating the supply of the resistor that takes place at the time indicated with tON, according to predefined modes described below, the tire is deflated and brought to the hot pressure value set P*=2 Bar. If pressure P is below P* the system will give an error signal and the tire shall have to be inflated.

Once the cold pressure has been brought to the value of P*, at time tON the resistor starts transferring heat to the tread of the tire and the temperature begins to slowly rise. When the temperature reaches the value T*=80° C. the thermostating begins.

The system is characterised by an appreciable thermal inertia. As a consequence, while the resistor is disconnected from the supply, the temperature continues to rise beyond the value T* (over-elongation) for some moments more to then drop by the effect of cooling. The resistor is supplied again when the temperature drops below T*. A hysteresis of few ° C. around T* is thus noted, which decreases as time passes and the system approaches the operating conditions.

The contribution of heat causes the gradual heating of the gas contained in the tire, causing a progressive increase of pressure P. The control device detects the instant value of pressure at regular intervals and records the variations, that is gradient GP. It is noted that the deflation is actuated periodically to keep the pressure value to value P*. As the system approaches the operating conditions, the pressure tends to oscillate increasingly less until the GP is less than GPL, a condition that determines the completion of the tire preparation.

According to a second operating mode, the tire is warmed letting the inner tire pressure P vary according to the course imposed by the tire warming.

Unlike the first operating mode, the pressure regulation is carried out only at the beginning of the process, before starting the warming. Basing on his/her experience, the user must set a cold pressure value Pf such that at the end of the warming process (T*−Tf), with thermally steady system, the final hot pressure actually is the desired one P*, or at most slightly higher for optionally allowing manual adjustment.

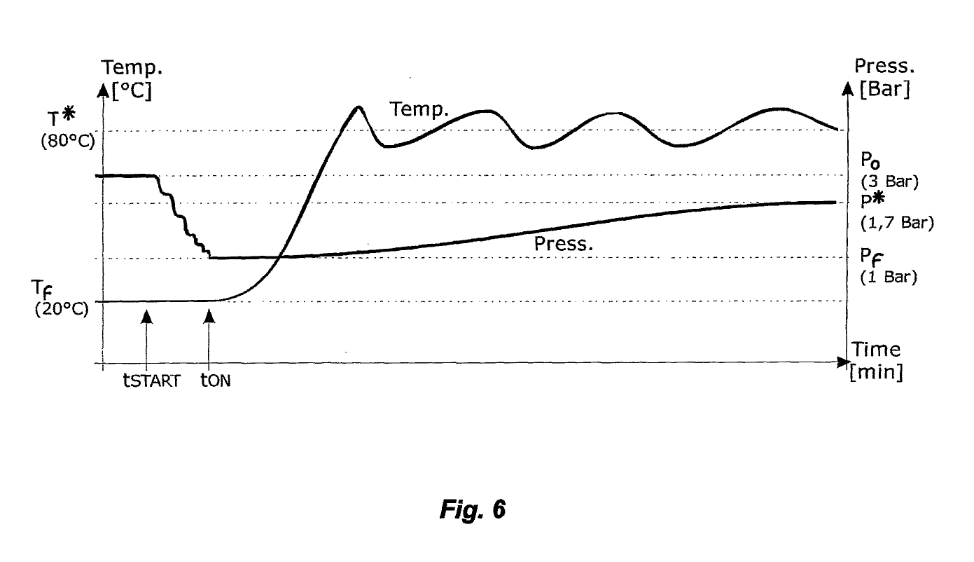

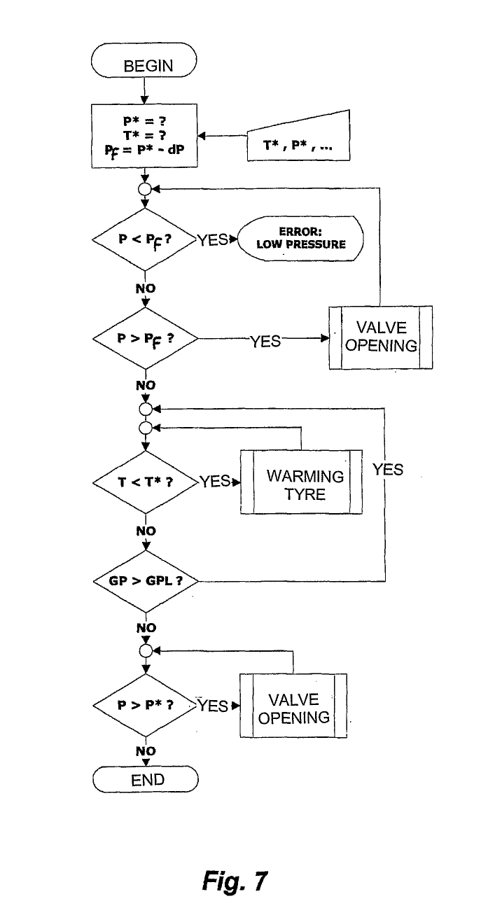

The logical diagram at the basis of this second operating mode is shown in FIG. 5, while the graph of FIG. 6 shows the overlapped time courses of pressure and temperature during the use of the tire warmer. The numerical values indicated are purely by way of an example.

In the example described by the diagram of FIG. 6, a value of 80° C. has been set for T* and a value of 1.7 bar for P*. It has been assumed to detect a cold temperature Tf equal to 20° C. A warming from 20° C. to 80° C. thus being established, assuming an isochor transformation (P=Po (1+αT), with α=1/273, 15[° C.]⁻¹, expansion coefficient of perfect gases, Po pressure at T=0° C.), the cold pressure must be equal to about 0.83 bar. The Pf is set to about 1 bar for precaution reasons.

According to a third operating mode, similar to the second operating mode, the tire is warmed letting the inner tire pressure P vary according to the course imposed by the tire warming.

In this case, the control device is programmed so that it automatically proceeds to the calculation of cold pressure, based on the detected value of cold temperature Tf and on the values set by the user for pressure P* and temperature T*.

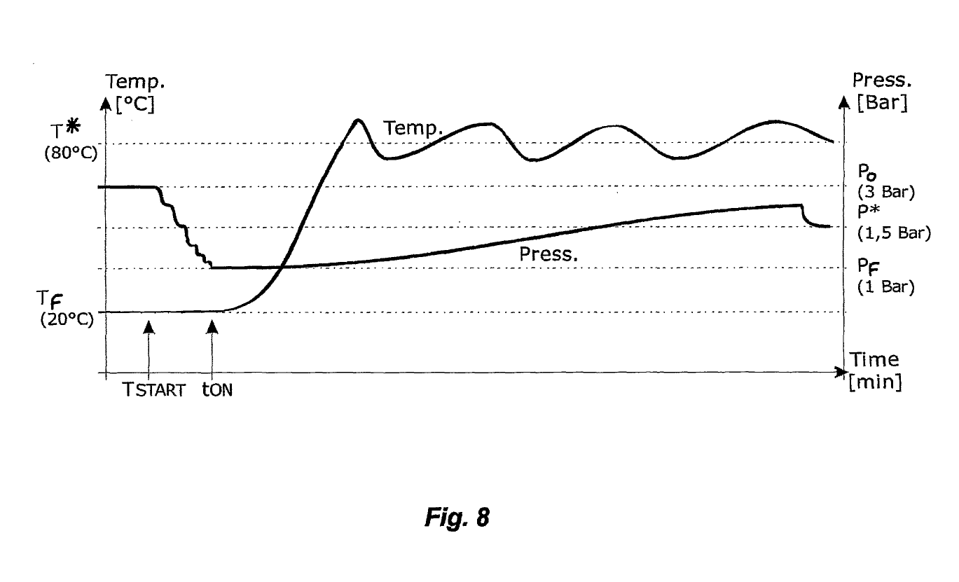

The logical diagram at the basis of this third operating mode is shown in FIG. 7, while the graph of FIG. 9 shows the overlapped time courses of pressure and temperature during the use of the tire warmer. The numerical values indicated are purely by way of an example.

More in detail, following the diagram of FIG. 7, the user sets the hot temperature T* and the hot pressure P*. The control device calculates the value of cold pressure Pf based on the values set P* and T* and on the cold temperature value Tf detected by the temperature sensor.

First, the pressure value P transmitted by the sensor is determined and if it is higher than Pf, the deflation electrovalve is actuated (according to specific modes described hereinafter) until the value of P is equal to P*. If P is less than Pf the device signals an error and the tire must be inflated.

When pressure P is equal to Pf, the value of temperature T is determined and, if it is less than the desired value T*, the resistor supply is activated. The program continues to control the temperature and to continue warming until the temperature T detected is equal or higher than T*.

Each time the temperature T reaches or exceeds value T* the electrical supply to the resistors is interrupted, the temporal gradient GP of pressure is determined.

If the pressure gradient detected GP is higher than a preset limit value GPL it means that there is still a temperature gradient between the tire tread and the support rim, that is, that the “tire+gas+rim” system is not thermally steady yet. In this case, the program checks the temperature T again.

Interrupting the heating allows the temperature to drop. The control cycle of T and of GP is repeated until T is less than T* again. The electrical supply to the resistors is then reactivated and the warming is resumed.

If the pressure gradient detected GP is less or equal to GPL it means that the system is at steady condition.

At this point the system checks the inner pressure P value, comparing it to the set value of hot pressure P.

If P is higher than P*, the deflation electrovalve is actuated (according to specific methods described hereinafter) until the value of P is equal to P*.

At this point, the control device signals that the wheel is ready for use. If the tire is not used immediately, the tire warmer continues to thermostat the system to the temperature value T* set.

As already mentioned before, the cold pressure value Pf is calculated with a certain margin so as to ensure in any case that the desired hot pressure P* is reached (and possibly exceeded) at the end of the heating. When the pressure gradient GP drops below the preset value GPL, the heating can be deemed as completed and the preparation of the tire ends with the final deflation to the value P* (if this is required).

To avoid variability of racing tire performance, it is essential to prepare the tire in repeatable conditions suitably managing the heating based on pressure P* and on hot temperature T*. From this point of view it is preferable to use tire warmer 10 according to the invention following the second and third operating mode.

As already mentioned before, the tire deflation by electrovalve may be carried out (both initially, to bring pressure to Pf, and at the end to reach the hot pressure P*) in various manners, which differ by speed and accuracy of the operation and are affected by the pressure sensor position.

If the pressure sensor is mounted connected to the pressure chamber 20 of the pressure regulating device, where there is also the deflation electrovalve, there occurs the inconvenience that when the electrovalve is actuated for bleeding the gas and thus acts opening a channel towards the exterior, the chamber pressure value drops to the ambient pressure value for all the time the electrovalve remains open. In these moments, therefore, it is not possible to obtain a readout of the pressure value of the tire from the sensor.

To deflate the tire from an initial value P0 to a final value P1 (Pf or P*) it is therefore necessary to proceed gradually, actuating the electrovalve by a predetermined time range and checking at each operation the value taken by the pressure after the partial deflation.

The electrovalve opening times substantially depend on the following parameters: inner tire volume; inner pressure; electrovalve bleeding flow.

On the contrary, when the pressure sensor is positioned inside the tire, a continuous reading of the pressure can be obtained even when the electrovalve is actuated. In this case, therefore, the deflation is an operation more easily controllable by the control device.

Advantageously, in particular in the case of pressure sensor connected to an external pressure chamber, two different deflation modes may be adopted: at predefined values and adaptive.

More in detail, defining ΔP as the difference between initial pressure P0 and final pressure P1 (ΔP=P0−P1) the mode at predefined values envisages that for different ranges of the ΔP value, different opening times are defined for the electrovalve. The higher the ΔP value, the higher the opening time. The table below shows some exemplifying values:

| | Electrovalve opening |
|---|---|
| Value of ΔP [Bar] | time [s] |
| ΔP ≧ 2 | 5 |
| 2 > ΔP ≧ 1 | 2 |
| 1 > ΔP ≧ 0.5 | 1 |
| 0.5 > ΔP ≧ 0.1 | 0.5 |
| 0.1 > ΔP ≧ 0.05 | 0.2 |

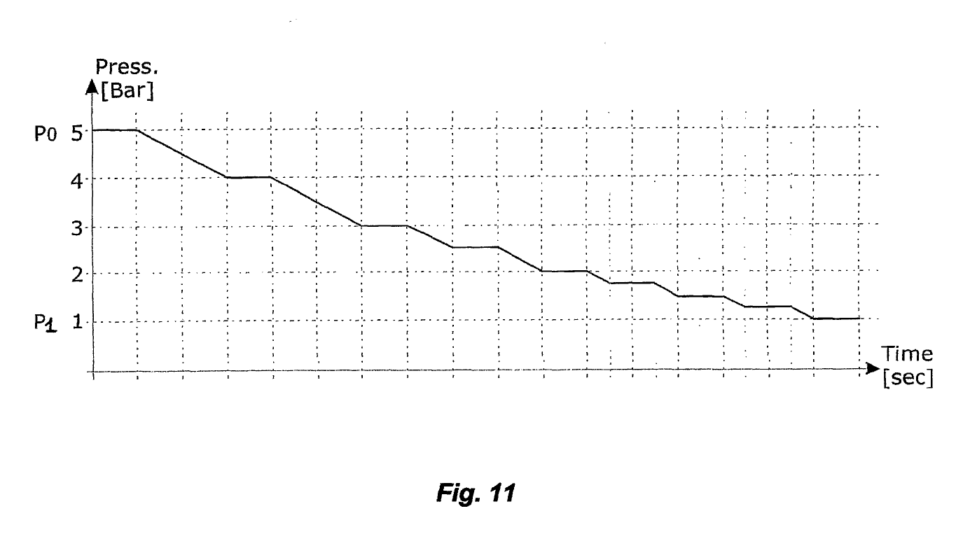

The greater the number of partial deflation steps (intervals of determination of ΔP), the higher will be the precision of the final pressure value Pf. The graph of FIG. 11 shows the tire pressure course following a deflation at predefined values.

Considering that after closing the electrovalve it is necessary to wait for a settling time (even 10 seconds) before measuring the pressure, the time for the deflation operation according to the method at predefined values may require even considerable times. A 3 step system has proved to be sufficiently reliable and accurate and quite fast.

Another limit of the mode just described is related to the fact that the electrovalve opening times must be set based on the tire size and the inner gas volume. In fact, as the tire size decreases, considering the gas volume reduction, the electrovalve opening times must be decreased suitably to ensure adequate deflation accuracy. This implies the need of providing for differentiated settings according to the tire sizes, to the disadvantage of the system convenience and flexibility.

To solve the above limits at least partly, the adaptive deflation mode may be used.

More in detail, this method provides for a first deflation step wherein the electrovalve is kept open by a first predefined time (e.g. 1 sec), selected so that the pressure does not drop below Pf or P*. This first step allows calibrating the system obtaining data for setting the electrovalve opening time of the next step.

Indicating with P0 the pressure value prior to deflation, with P1 the pressure value at the end of the first deflation step, with dP the difference between P0 and P1 (dP=P0−P1) and dt the electrovalve opening time in the passage from P0 to P1, the dt value of the next step is obtained based on considerations of proportionality and assessment of the errors on the effective value P1 compared to the expected one Pf or P*. This mode allows minimising the number of steps and thus the overall deflation time.

In conjunction or separately from the above description, a further object of the present invention is a method for warming tires, in particular tires to be used in motor-cycling and motor-racing.

According to a general embodiment, the method comprises the following steps:

providing electrical resistor means wrappable around a tire;

providing means for detecting the inner pressure P of the tire;

providing means for detecting the temperature T of the tire;

setting the final warming temperature T* of the tire;

warming the tire by the electrical resistor means, regulating the activation and deactivation of the latter so as to thermostat the temperature of the tire at the predefined warming temperature T*;

once reached the preset temperature value T*, determining the inner pressure gradient over time GP of the tire; and

taking as thermal gradient absence indicator in the tire wall thickness an inner pressure gradient over time GP close to zero.

Preferably, the method comprises a step of providing means for regulating the inner pressure P of the tire.

According to a first particular embodiment, the method further comprises the following steps:

setting a value of the hot inner pressure P* of the tire; and

actuating the regulating means for keeping the inner pressure P about equal to the preset value of hot pressure P*.

Preferably, according to the above first embodiment, the method also comprises a step of regulating the cold pressure Pf of the tire to a value not below the preset hot pressure value P*.

According to a second embodiment, the method further comprises the following steps:

setting a value of the hot inner pressure P* of the tire;

detecting the cold temperature Tf of the tire;

calculating the cold inflation pressure Pf based on the detected value of cold temperature Tf and of the preset temperature T* and hot pressure P* values of the tire;

actuating the regulating means of the inner pressure for bringing the inner pressure P of the wheel to the cold pressure Pf before starting the warming step.

In the practice it has been noted that the invention achieves the task and the objects by providing a tire warmer capable of indicating to the user when the entire thickness of the tire reaches the preset temperature and that further allows setting and regulating the pressure of the gas contained by the tire.

Several changes and variations can be made to the invention thus conceived, all falling within the scope of the inventive concept; moreover, all details can be replaced with technically equivalent elements.

In the practice, the materials used as well as the sizes and shapes can be whatever, according to the technical requirements and to the prior art.

Where the features and techniques mentioned in any claims are followed by references, such references have been added only for the purpose of increasing the intelligibility of the claims and thus, such references have no limiting effect on the interpretation of each element identified by such references only by way of an example.

1-28. (canceled)

29. Tire warmer, in particular for tires to be used in motor-cycling and motor-racing, comprising a body wrappable to the wheel at the tyre and seating a resistor for warming said tyre, connected to electrical supply means actuable by a control device connected to a temperature sensor associable to said wheel for detecting the temperature of said tyre, characterised in that it comprises a regulating device of the pressure of gas contained by said tyre.

30. Tire warmer according to claim 29, wherein said control device is set for actuating said electrical supply means according to the pressure gradient over time (GP) detected inside said tyre.

31. Tire warmer according to claim 30, wherein said control device is set for considering a pressure gradient over time (GP) close to zero as indicator of absence of thermal gradient in the wall thickness of said tire.

32. Tire warmer according to claim 31, wherein a pressure gradient (GP) is considered substantially close to zero when it is below 0.1 mbar/s, and preferably when it is below 0.040 mbar/s.

33. Tire warmer according to claim 29, characterised in that said regulating device comprises a device for detecting the pressure of gas contained by said tire.

34. Tire warmer according to claim 33, characterised in that said regulating device comprises a pressure chamber, connected to said wheel and suitable for seating part of the gas contained by said tire, said detection device comprising a pressure sensor, connected to said pressure chamber for detecting the pressure of the gas contained therein, said regulating device comprising a deflation electrovalve connected to said pressure chamber for the on-command ejection of the gas contained in said pressure chamber.

35. Tire warmer according to claim 34, characterised in that said detection device is connected to said control device by said pressure sensor and by said electrovalve respectively for detecting and regulating the pressure of the gas contained in said pressure chamber.

36. Tire warmer according to claim 33, characterised in that said regulating device comprises a pressure chamber, connected to said wheel and suitable for seating part of the gas contained by said tire, said detection device comprising a pressure sensor, connected directly to the inner chamber of said tire for detecting the pressure of the gas contained therein, said regulating device comprising a deflation electrovalve connected to said pressure chamber for the on-command ejection of the gas contained therein.

37. Tire warmer according to claim 36, wherein said detection device is connected to said control device by said pressure sensor for detecting the pressure of the gas contained in said wheel and by electrovalve for regulating the pressure of the gas contained in said pressure chamber.

38. Tire warmer according to claim 29, characterised in that said control device comprises a setting device, controllable by the user, for the hot (P*) and/or cold (Pf) inflation pressure of said tire and of the warming temperature (T*) of said tire.

39. Tire warmer according to claim 38, wherein said control device is suitable for intervening on said electrovalve for keeping the detected pressure value (P) to a preset value (P*) of said hot inflation pressure.

40. Tire warmer according to claim 38, wherein said control device detects the cold temperature (Tf) of said tire, and is suitable for calculating the cold inflation pressure (Pf) corresponding to the preset values of hot inflation pressure (P*) and of the warming temperature (T*) and is suitable for intervening on said electrovalve for bringing the inner pressure (P) of said wheel to said cold pressure (Pf) before warming said tire.

41. Tire warmer according to claim 34, characterised in that said control device comprises a setting device, controllable by the user, for the cold (Pf) inflation pressure of said tire and of the warming temperature (T*) of said tire and is set for intervening on said electrovalve for bringing the inner pressure (P) of said wheel to said preset value of cold pressure (Pf) before warming said tire.

42. Method for warming tires, in particular tires to be used in motor-cycling and motor-racing, comprising the following steps:
providing electrical resistor means wrappable around a tire;
providing means for detecting the inner pressure (P) of said tire;
providing means for detecting the temperature (T) of said tire;
setting the final warming temperature (T*) of said tire;
warming said tire by said electrical resistor means, regulating the activation and deactivation of the latter so as to thermostat the temperature of said tire at said predefined warming temperature (T*);
once reached said preset temperature value (T*), determining the inner pressure gradient over time (GP) of said tire; and
taking as thermal gradient absence indicator in the tire wall thickness an inner pressure gradient over time (GP) close to zero.

43. Method according to claim 42, comprising the step of providing means for regulating the inner pressure (P) of said tire.

44. Method according to claim 43, comprising the step of:
setting a value of hot inner pressure (P*) of said tire;
actuating said regulating means for keeping the inner pressure (P) about equal to said preset value of hot pressure (P*).

45. Method according to claim 44, comprising the step of inflating the tire to a pressure (P) not below said predefined value of hot pressure (P*).

46. Method according to claim 43, comprising the step of:
setting a value of hot inner pressure (P*) of said tire;
detecting the cold temperature (Tf) of said tire;
calculating the cold inflation pressure (Pf) based on the detected value of cold temperature (Tf) of said tire and of the preset temperature (T*) and hot pressure (P*) values of said tire;
actuating said regulating means of the inner pressure for bringing the inner pressure (P) of said wheel to said cold pressure (Pf) before starting said warming step of said tire.
